(19) United States
(12) Patent Application Publication
(10) Pub. No.: US 2020/0359871 A1
(43) Pub. Date: Nov. 19, 2020

(54) METHOD FOR CLEANING ALONG EDGE AND CLEANING ROBOT

(71) Applicant: Shenzhen Silver Star Intelligent Technology Co., Ltd., Shenzhen (CN)

(72) Inventors: Yingcong FENG, Shenzhen (CN); Xianhua LIANG, Shenzhen (CN); ZHENKUN SUN, Shenzhen (CN)

(21) Appl. No.: 16/578,202

(22) Filed: Sep. 20, 2019

(30) Foreign Application Priority Data
May 15, 2019 (CN) 201910408193.7

(51) Int. Cl. A47L 11/40; A47L 9/00; A47L 9/28; G05D 1/02

(52) U.S. Cl. CPC A47L 11/4011; A47L 11/4061; A47L 9/009; A47L 9/2815; G05D 2201/0203; A47L 11/4066; G05D 1/024; G05D 1/0219; A47L 2201/04; A47L 9/2852

(57) ABSTRACT

The present application discloses a method for cleaning along an edge, and a cleaning robot. The method includes ensuring that an object to be followed is found, rotating along a direction in which a tracking transducer gradually approaches the object to be followed and recording a plurality of values from the tracking transducer, determining an extreme value from the tracking transducer according to the plurality of values from the tracking transducer, stopping rotating if a current value from the tracking transducer and the extreme value from the tracking transducer satisfy a preset relationship, moving along a contour edge of the object to be followed in a current orientation.

### CROSS REFERENCE TO RELATED APPLICATIONS

This application claims priority to Chinese Patent Application No. 201910408193.7 filed on May 15, 2019, the content of which is incorporated herein by reference in its entirety.

### TECHNICAL FIELD

The present application relates to a technical field of robots, and particularly to a method for cleaning along an edge, and a cleaning robot.

### BACKGROUND

Cleaning robots are used for cleaning work, such as dust absorption, cleaning up, washing etc., for the floor. With the development of artificial intelligence, the cleaning robots are provided with functions such as intelligent obstacle avoidance, prevention of being stuck, automatic charging, and autonomous navigation for path planning, and the like, so that intellectualization of the cleaning robots has been greatly improved, and the entire cleaning process does not need manual control, which greatly liberates people's hands. Therefore, the cleaning process saves time and effort, and is increasingly favored by young people.

Cleaning along an edge is one of the important functions of the cleaning robots, which means that a robot cleans up when the robot moves along a contour edge of an object. When the robot performs cleaning along an edge, it is necessary to find an object to be followed first, and the object to be followed may be an object arranged on the floor, such as a wall, a piece of furniture, and an appliance etc.

There are many ways to find an object to be followed, which includes, depending on its sensor, at least two ways: first, when the edge of the robot collides with the object, a sensor for sensing a collision is triggered, and it is considered that the object to be followed is found; second, when a ranging sensor on the robot measures a proper distance between the object and the robot, it is considered that the object to be followed is found. After finding the object to be followed, the robot needs to rotate to be substantially parallel to the contour edge of the object to be followed, and then cleans along the edge.

However, when rotating, most of the cleaning robots can be generally parallel to the contour edge of the object to be followed after multiple collisions or multiple position adjustments, therefore the probability of damage to items such as a wall, a piece of furniture, and an appliance etc. is increased, the robot movements appear stiff and clumsy, and the user experience is not good.

### SUMMARY

The present application aims to solve problems in the art that the cleaning robots require multiple collisions or multiple position adjustments to be generally parallel to the contour edge of the object to be followed, and that the items are easy to be damaged and the movements are stiff and clumsy. Therefore, a method for cleaning along an edge, and a cleaning robot are proposed.

In order to solve the above technical problems, the present application adopts the following one technical solution.

A method for cleaning along an edge, performed by a cleaning robot, including:

ensuring that an object to be followed is found;

rotating along a direction in which a tracking transducer gradually approaches the object to be followed, and recording a plurality of values from the tracking transducer;

determining an extreme value from the tracking transducer according to the plurality of values from the tracking transducer;

stopping rotating if a current value from the tracking transducer and the extreme value from the tracking transducer satisfy a preset relationship;

moving along a contour edge of the object to be followed in a current orientation. Usually, it only needs rotating once to adjust the position and to be parallel to the contour edge of the object to be followed. The motion is smooth and unhindered, and the items will not be subjected to damage due to multiple adjustments and collisions, thereby the user experience is better.

Alternatively, the step of determining an extreme value from the tracking transducer according to the plurality of values from the tracking transducer comprises: determining a maximum value from the tracking transducer according to the values from the tracking transducer;

the step of stopping rotating if a current value from the tracking transducer and the extreme value from the tracking transducer satisfy a preset relationship comprises: stopping rotating if the current value from the tracking transducer is less than or equal to a preset multiple of the maximum value from the tracking transducer.

Alternatively, the tracking transducer comprises an infrared emitter and an infrared sensor, and the values from the tracking transducer involve in intensity information generated by the infrared sensor.

Alternatively, he step of determining an extreme value from the tracking transducer according to the plurality of values from the tracking transducer comprises: determining a minimum value from the tracking transducer according to the values from the tracking transducer;

the step of stopping rotating if a current value from the tracking transducer and the extreme value from the tracking transducer satisfy a preset relationship comprises: stopping rotating if the current value from the tracking transducer is larger than or equal to a preset multiple of the minimum value from the tracking transducer.

Alternatively, the tracking transducer comprises a ranging sensor, and the values from the tracking transducer involve in distance information generated by the ranging sensor.

Alternatively, after moving along a contour edge of the object to be followed in a current orientation, the method further comprises: adjusting distance between the cleaning robot and the contour edge of the object to be followed during movement with reference to the current value from the tracking transducer, keeping a suitable, stable distance.

In order to solve the above technical problems, the present application further adopts the following one technical solution.

A cleaning robot, including:

a robot body, a side portion of which is provided with a tracking transducer;

a mechanism for driving wheels, configured to drive the robot body to rotate and move;

a cleaning mechanism, configured to cleaning up garbage on the ground; and

a processor, configured to:

ensure that an object to be followed is found;

control the robot body to rotate along a direction in which a tracking transducer gradually approaches the object to be followed, and record a plurality of values from the tracking transducer;

determine an extreme value from the tracking transducer according to the plurality of values from the tracking transducer;

control the robot body to stop rotating if a current value from the tracking transducer and the extreme value from the tracking transducer satisfy a preset relationship;

control the robot body to move along a contour edge of the object to be followed in a current orientation. Usually, it only needs rotating once to adjust the position and to be parallel to the contour edge of the object to be followed. The motion is smooth and unhindered, and the items will not be subjected to damage due to multiple adjustments and collisions, thereby the user experience is better.

Alternatively, the processor is configured to:

determine a maximum value from the tracking transducer according to the values from the tracking transducer;

control the robot body to stop rotating if the current value from the tracking transducer is less than or equal to a preset multiple of the maximum value from the tracking transducer.

Alternatively, the tracking transducer comprises an infrared emitter and an infrared sensor, and the values from the tracking transducer involve in intensity information generated by the infrared sensor.

Alternatively, the processor is configured to:

determine a minimum value from the tracking transducer according to the values from the tracking transducer;

control the robot body to stop rotating if the current value from the tracking transducer is larger than or equal to a preset multiple of the minimum value from the tracking transducer.

Alternatively, the tracking transducer comprises a ranging sensor, and the values from the tracking transducer involve in distance information generated by the ranging sensor.

Alternatively, after moving along a contour edge of the object to be followed in a current orientation, the cleaning robot further comprises: adjusting distance between the cleaning robot and the contour edge of the object to be followed during movement with reference to the current value from the tracking transducer, keeping a suitable, stable distance.

### DESCRIPTION OF THE DRAWINGS

In order to more clearly illustrate the embodiments of the present application or the technical solutions in the prior art, the drawings used in the description of the embodiments or the prior art will be briefly described below. Obviously, the drawings described below are only some embodiments of the present application, and other variations may also be obtained based on these drawings by those skilled in the art without paying creative effort.

FIG. 1 is a schematic view showing a stereoscopic structure of a cleaning robot according to an embodiment of the present application.

FIG. 2 is a schematic view showing the structure of the cleaning robot when a dust box is separated therefrom.

FIG. 3 is a cross-sectional view taken along line A-A of FIG. 1.

FIG. 4 is a cross-sectional view taken along line B-B of FIG. 1.

FIG. 5 is a schematic view showing a stereoscopic structure of a cleaning robot having a rectangular front portion and an arc-shaped rear portion.

FIG. 6 is a schematic view showing a stereoscopic structure of a cleaning robot having a triangular-like outline.

FIG. 7 is a schematic view showing a structure of a fan assembly.

FIG. 8 is an exploded structure view of the fan assembly of FIG. 7.

FIG. 9 is a schematic view showing a stereoscopic structure of the dust box of FIG. 2.

FIG. 10 is a schematic view showing the structure of the dust box of FIG. 9 when it is opened.

FIG. 11 is a cross-sectional view taken along line C-C of FIG. 9.

FIG. 12 is a schematic view showing a cross section of a tracking transducer.

FIG. 13 is a flow chart of steps of a method performed by a processor.

FIG. 14 is a schematic view of a cleaning robot, the structure of which has been simplified.

FIGS. 15-17 are schematic diagrams showing three states of the cleaning robot of FIG. 14 with a tracking transducer disposed at left front when it encounters an object to be followed.

FIGS. 18-20 are schematic diagrams showing three states of the cleaning robot with a tracking transducer disposed at right front when it encounters an object to be followed.

FIG. 21 is a change curve plotted according to values of the tracking transducer involving in intensity information.

FIG. 22 is a change curve plotted according to values of the tracking transducer involving in distance information.

FIG. 23 is a flow chart showing steps of a method for cleaning along an edge according to another embodiment of the present application.

### DETAILED EMBODIMENTS

The technical solutions in the embodiments of the present application will be clearly described with reference to the accompanying drawings in the embodiments of the present application. It is obvious that the described embodiments are only a part of the embodiments, and not all of the embodiments of the present application. Based on the embodiments of the present application, all other embodiments obtained by those skilled in the art without paying creative efforts are within the scope of the present application.

As shown in FIG. 1 to FIG. 4, an embodiment of the present application provides a cleaning robot 10 including a robot body 100, a mechanism for driving wheels, a cleaning mechanism, and a processor 410.

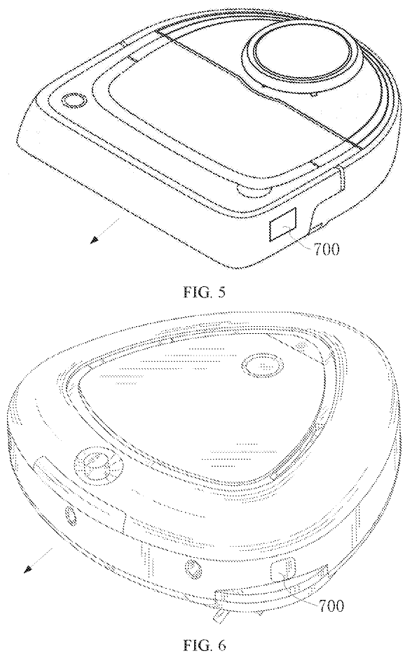

The outline of the robot body 100 is provided as, but is not limited to, a circular structure in FIG. 1, a structure having a rectangular front portion and an arc-shaped rear portion in FIG. 5, and a triangular-like structure in FIG. 6.

The mechanism for driving wheels is fitted with the robot body 100, and is configured to drive the robot body 100 to rotate and move. In an embodiment of the present application, the mechanism for driving wheels may include a left wheel 110 and a right wheel (not shown) provided at a bottom of the robot body 100, and the left wheel 110 and the right wheel are symmetrically arranged with a center axis E of the robot body 100. In order to realize the functions of rotation and movement, the left wheel 110 and the right wheel are respectively connected to one motor, that is, a motor for the left wheel that drives the left wheel 110 to rotate, and a motor for the right wheel that drives the right wheel to rotate.

In an embodiment of the present application, the left wheel 110 and the right wheel are round wheels, rims of which are sleeved with a rubber tire. An outer surface of the rubber tire is provided with an anti-slip protrusion or texture to increase friction and grip when the left wheel 110 and the right wheel rotate on the floor, thereby adapting to different types of floor, such as floor tiles and wooden floors with a smooth surface, and carpets with a rough surface etc. In other embodiments, the mechanism for driving wheels may further include a left crawler wheel and a right crawler wheel disposed at the bottom of the robot body 100, and a motor for the left crawler wheel that drives the left crawler wheel to rotate, and a motor for the right crawler wheel that drives the right crawler wheel to rotate.

In order to improve stability and facilitate steering during the movement, the bottom of the robot body 100 may further be provided with at least one universal wheel 130, and the universal wheel 130 is preferentially disposed on the central axis E. Based on this, the universal wheel 130, the left wheel 110 and the right wheel are arranged in an isosceles-triangular shape at the bottom of the robot body 100.

In an embodiment of the present application, the cleaning robot 10 provides a function of inhaling garbage, such as dust, debris etc. on the floor. In order to realize the function of inhaling the garbage, the cleaning mechanism includes: a fan assembly 200 disposed inside the robot body 100, and a dust box 300 disposed at the robot body 100 and used to store the garbage inhaled from the floor. The dust box 300 is detachably mounted on a side of the rear portion of the robot body 100. In other embodiments, the dust box 300 may also be disposed in an accommodating groove at the top position of the robot body 100, and may be taken out from the accommodating groove, and the dust box 300 may be mounted in the accommodating groove.

In addition to the function of inhaling the garbage, the cleaning robot 10 may also provide a function of wiping the floor. For example, the cleaning robot 100 is assembled with a mopping assembly at rear bottom thereof. When the mopping assembly is distinguished according to different manners of mopping the floor, the mopping assembly may be one mopping the floor through flatly pushing or one mopping the floor through rolling; when the mopping assembly is distinguished according to whether the mopping assembly is wet during mopping the floor, the mopping assembly may be a dry type or a wet type. In other embodiments, the cleaning robot 10 may provide the function of wiping the floor but not provide the function of inhaling the garbage.

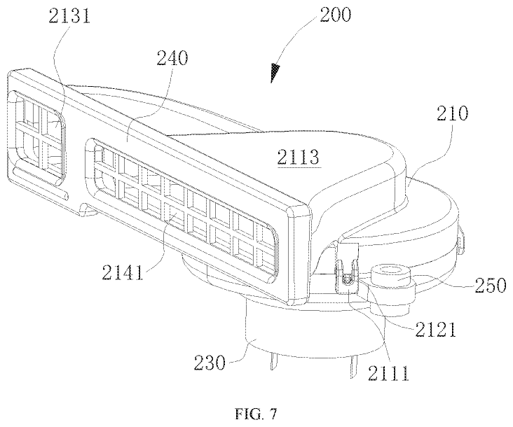

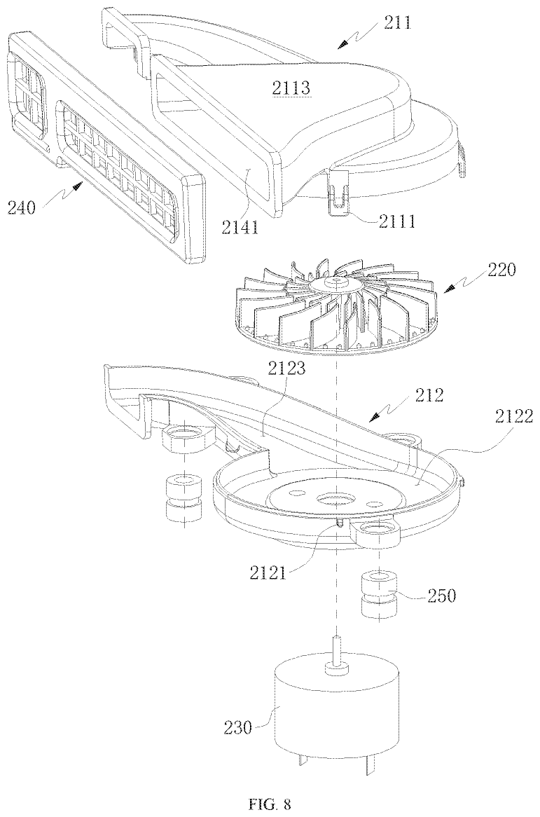

As shown in FIGS. 7 and 8, the fan assembly 200 includes a housing 210, a fan 220, and a fan motor 230. The housing 210 includes an upper housing 211 and a lower housing 212 that are fastened together. The upper housing 211 and the lower housing 212 may be connected through snap-fit connection. Specifically, a plurality of fasteners 2111 extend in a direction facing toward the lower housing 212 from a side of the upper housing 211 contacting the lower housing 212, and the plurality of fasteners 2111 are spaced on the side of the upper housing 211. Correspondingly, a plurality of protrusions 2121 extend from a side of the lower housing 212 contacting the upper housing 211, and each of the fasteners 2111 are matingly engaged with one protrusion 2121, such that the upper housing 211 and the lower housing 212 that are fastened together are more firm and compact. In other embodiments, the upper housing 211 and the lower housing 212 may also be connected by a threaded fastener or may be connected by an adhesive.

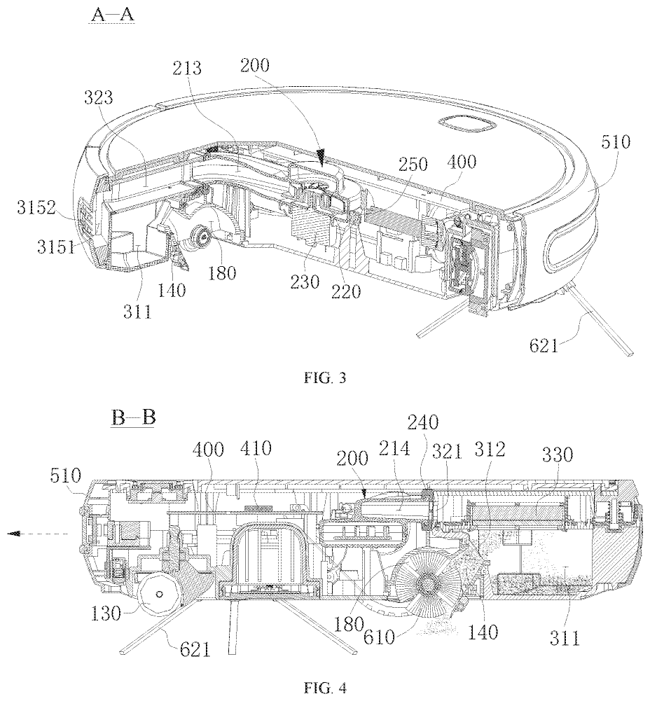

The lower housing 212 is formed with a first housing groove 2122 and a first air-out groove 2123 formed by extending outwardly, and the first housing groove 2122 is in communication with one end of the first air-out groove 2123. Correspondingly, the upper housing 211 is formed with a second housing groove (not shown) and a second air-out groove formed by extending outwardly, and the second housing groove is in communication with one end of the second air-out groove. When the upper housing 211 and the lower housing 212 are fastened together, the first housing groove 2122 and the second housing groove are joined together to form a cavity for accommodating the fan 220, and the first air-out groove 2123 and the second air-out groove are joined together to form an air-out channel. Referring to the air-out channel 213 indicated in FIG. 3, the other end of the first air-out groove 2123 and the other end of the second air-out groove are formed with an air-out hole 2131.

The upper housing 211 includes an integrally formed air-in tube body 2113. The air-in tube body 2113 has a flat and wide structure, and its interior is formed with an air-in channel 214. One end of the air-in channel 214 is in communication with the cavity for accommodating the fan 220, and the other end of the air-in channel 214 is formed with an air-in hole 2141. The cross-sectional area of the air-in channel 214 gradually increases from one end to the other end thereof, and is substantially in a flat and wide shape.

The fan motor 230 is fixed to an outer side of the lower housing 212, and a rotating shaft of the fan motor 230 extends through the lower housing 212 into the first housing groove 2122, and the fan 220 is coupled to the rotating shaft of the fan motor 230. When the fan motor 230 drives the fan 220 to rotate, the fan 220 drives airflow to flow in from the air-in hole 2141 of the air-in channel 214, and to be exhausted from the air-out hole 2131 of the air-out channel 2131. Since it will cause vibration and increase noise when the rotating shaft of the fan motor 230 drives the fan 220 to rotate, a soft member 250 may be arranged between the fan assembly 200 and the robot body 100 to achieve connection, and the soft member 250 may act as a buffer, shock reducer and noise absorber.

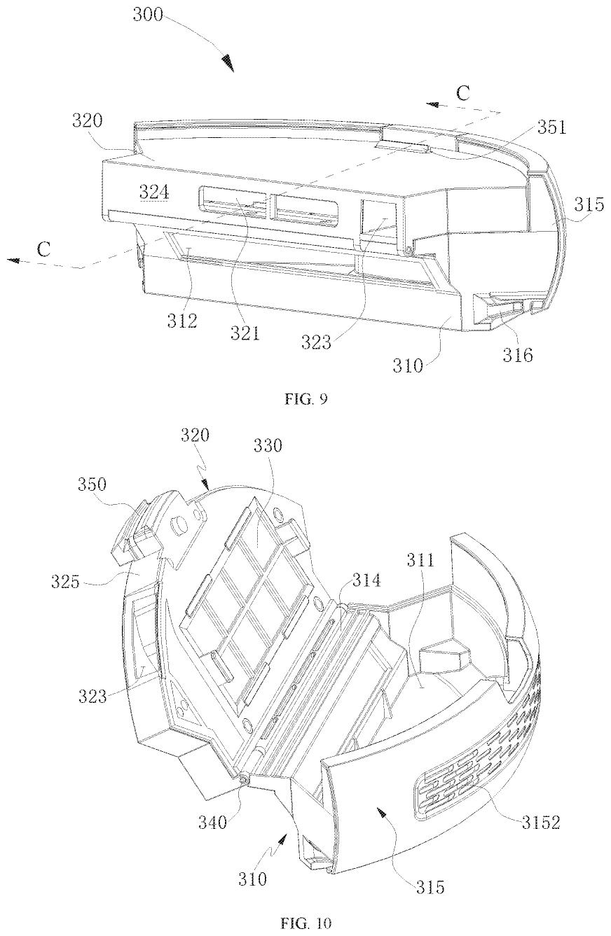

As shown in FIG. 9 to FIG. 11, the dust box 300 includes a box body 310, a cover 320, and a filter element 330 detachably mounted on an inner side of the cover 320. The box body 310 is provided with a dust collection chamber 311 therein, and the box body 310 is provided with a dust inlet 312 in communication with the dust collection chamber 311. The cover 320 is pivotally coupled to the box body 310 and covers the top of the box body 310. Referring to the schematic view of FIG. 9 showing a state when the cover 320 covers the box body 310, and the schematic view of FIG. 10 showing a state when the cover 320 is pivotally opened relative to the box body, the cover 320 may be opened and the garbage can be dumped out when enough garbage is accumulated in the dust collection chamber 311. The cover 320 is provided with an air outlet 321 and an air exhaust channel 323. The air outlet 321 is in communication with the dust collection chamber 311 via the filter element 330, and the cover 320 is further provided with an air exhaust channel 323.

In a practical application, when the box body 310 is assembled on a side of the robot body 100, the dust inlet 312 is connected to an air inlet groove 140 provided at the bottom of the robot body 100. Meanwhile, the air outlet 321 is in communication with the air-in channel 214, that is, the air outlet 321 is connected to the air-in hole 2141, and the air exhaust channel 323 is further in communication with the air-out channel 213, i.e., an opening at one end of the air exhaust channel 323 is connected to air-out hole 2131.

In order to increase the air impermeability, a sealing gasket may be provided at a corresponding position of the cleaning robot 10 as needed. For example, as shown in FIG. 11, a first sealing gasket 313 may be provided at the position of the dust inlet 312. When the dust inlet 312 is connected with the air inlet groove 140, a part of airflow is prevented from leaking from a gap between the dust inlet 312 and the air inlet groove 140 since the first sealing gasket 313 is sandwiched therebetween (the air leakage results in reduces air pressure and affects the effect of dust collection). For example again, as shown in FIG. 4 and FIG. 7, a second sealing gasket 240 is disposed at the position of the air-in hole 2141 and the air-out hole 2131, and the second sealing gasket 240 covers edges of the air-in hole 2141 and the air-out hole 2131. When the air outlet 321 is connected to the air-in hole 2141, the second sealing gasket 240 sandwiched therebetween can effectively prevent a part of the airflow from leaking from a gap between the air outlet 321 and the air-in hole 2141 (the air leakage results in reduced air pressure and affects the effect of dust collection). Similarly, when an opening at one end of the air exhaust channel 323 is connected to the air-out hole 2131, the second sealing gasket 240 sandwiched therebetween can effectively prevent a part of the airflow from leaking from a gap between opening at one end of the air exhaust channel 323 and the air-out hole 2131 (the air leakage results in reduced air pressure and affects the effect of dust collection).

In an embodiment of the present application, the robot body 100 is provided with a receiving notch 150 at a side with its size adaptable for the dimension of the dust box 300. The dust box 300 is assembled in the receiving notch 150, and the dust box 300 is integrated into the robot body 100, which has a more aesthetic feeling on exterior design. In other embodiments, the dust box 300 may also be configured to be directly mounted on a side of the robot body 100 without affecting the air flow passage among the dust box 300, the air inlet groove 140 and the fan assembly 200, that is, the dust box 300 protrudes from a side of the robot body 100.

In an embodiment of the present application, the cover 320 and the box body 310 are both provided with a flat side portion and a peripheral side portion disposed oppositely, and the flat side portion 324 of the cover 320 is pivotally coupled to the flat side portion 314 of the box body 310 through a pin shaft 340, which improves the sealing of the joint between the cover 320 and the box body 310. Since the robot body in this embodiment is roughly a flat-shaped cylinder, the peripheral side portion 325 of the cover 320 and the peripheral side portion 315 of the box body 310 may each have an arc-shaped structure on this basis, and when the dust box 300 is assembled in the receiving notch 150, the periphery formed by the robot body 100 and the dust box 300 has a circular annular structure.

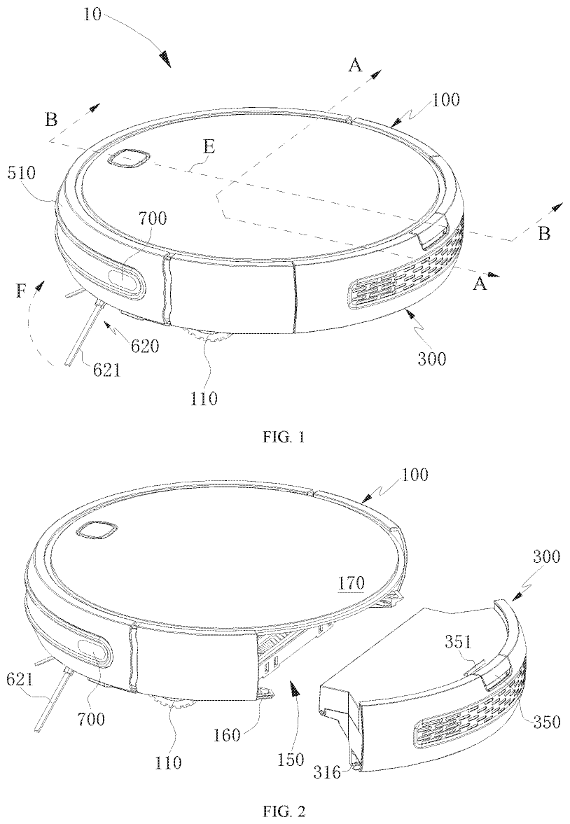

In an embodiment of the present application, as shown in FIG. 2 and FIG. 9, the box body 310 has two oppositely disposed side portions, each of the side portions is provided with a positioning slot 316, and a positioning tongue 160 is convexly disposed in the receiving notch 150. When the dust box 300 is assembled in the receiving notch 150, the positioning tongue 160 extends into the positioning notch 316 to play a positioning role so as to prevent the dust box 300 from shaking in the receiving notch 150. In addition, a cover plate 170 is disposed on the top of the robot body 100, a part of the edge of the cover plate 170 extends to the peripheral side portion 315 of the box body 310, the peripheral side portion 325 of the cover 320 is provided with a press-type buckle member 350, and a stop portion 351 of the buckle member 350 is engaged with the cover plate 170. During a practical operation, when the buckle member 350 is pressed by a finger, the stop portion 351 is disengaged from the cover plate 170, so that the dust box 300 may be withdrawn from the receiving notch 150.

In an embodiment of the present application, as shown in FIG. 3, the peripheral side portion 315 of the box body 310 is provided with a receiving cavity 3151 therein, and silencer cotton may be provided in the receiving cavity 3151 to eliminate noise. When the cover 320 covers the top of the box body 310, the air exhaust channel 323 is in communication with the receiving cavity 3151. The peripheral side portion 315 of the box body 310 is further provided with an air exhaust hole 3152 in communication with the receiving cavity 3151, and the air exhaust hole 3152 may be provided at the peripheral side portion 315 of the box body 310 at an oblique upward angle, so that the airflow exhausted from the air exhaust hole 3152 is prevented from being blown toward the ground and the dust on the ground is prevented from being raised. In order to further eliminate the noise, the silencer cotton may be selectively disposed in the air exhaust channel 323, the air-in channel 214, and the air-out channel 213 as needed.

When the cleaning robot 10 is working normally, the bottom of the robot body 100 is close to the ground to be cleaned and the fan motor 230 drives the fan 220 to rotate, such that the airflow doped with garbage such as dust, debris and the like enters the dust collection chamber 311 sequentially through the air inlet groove 140 and the dust inlet 312, and the garbage such as dust, debris and the like in the airflow is filtered and stored in the dust collection chamber 311 by using the filtering function of the filter element 330. The filtered airflow enters the fan assembly 200 from the air outlet 321, and enters the air exhaust channel 323 provided by the dust box 300 after sequentially passing through the air-in channel 214 and the air-out channel 213 of the fan assembly 200, and is exhausted to the outside of the cleaning robot 10 through the air exhaust channel 323. As a whole, the air passage formed is long, which is favorable for noise elimination. Moreover, the airflow is finally exhausted to the outside of the cleaning robot 10, so that the cleaning robot 10 itself can form a relatively sealed space, and it is not easy for the dust to enter the inside of the cleaning robot 10 to affect the cleaning work and the normal operation of the circuit board.

The cleaning robot 10 may move in a forward or backward direction. The robot body 100 has a corresponding front end and a rear end, and one end where the universal wheel 130 is located is defined as the front end. In this embodiment, the front end of the robot body 100 is formed with a collision component 510, and the collision component 510 has a shape that matches the shape of the front end of the robot body 100, for example, in an arc-shaped configuration. In other embodiments, a collision component 510 having an annular structure is formed around a circular side of the robot body 100. A plurality of collision sensors, such as a micro switch, a Hall switch, and the like, may be disposed at intervals between the collision component 510 and the robot body 100. When different regions of the collision component 510 collide with an obstacle such as an electric appliance or furniture or the like, a collision sensor corresponding to the region being collided is triggered. Therefore, the cleaning robot 10 may acquire which region of the collision component 510 collides with the obstacle, and then take an obstacle avoidance action such as steering or rebounding or the like.

In an embodiment of the present application, the cleaning mechanism further includes a rolling brush 610 for cleaning, the rolling brush 610 for cleaning is disposed in a receiving groove 180 formed at the bottom of the robot body 100, and the air inlet groove 140 is provided at an inner side wall of the receiving groove 180. The rolling brush 610 for cleaning may be any one or a combination of a cleaning hairbrush and a cleaning rubber brush. The cleaning mechanism may further include a side brush 620 driven by a motor, and the side brush 620 is arranged at the left front portion and/or the right front portion of the robot body 100. The side brush 620 may rotate along an axis that is substantially perpendicular to the ground, as shown in FIG. 1, the side brush 620 rotates along the direction indicated by the arrow F. The side brush 620 is provided with a plurality bundle of long bristles 621 arranged spaced around an axis, the long bristles 621 extend outward and beyond the outline of the robot body 100 for cleaning the garbage on the ground beyond the outline of the robot body 100 to the position of the receiving groove 180 arranged at the bottom of the robot body 100. One or two side brushes 620 may be arranged at the bottom of the robot body 100.

In an embodiment of the present application, the cleaning robot 10 further includes a printed circuit board 400 disposed inside the robot body 100. The printed circuit board 400 is loaded with a processor 410, a memory, a peripheral circuit, an input/output component, and the like. The processor 410 may be a microcontroller unit (MCU), or may be a CPU, PLC, DSP, SoC, FPGA, etc., and the processor 410 may be a single integrated circuit or a collection of multiple integrated circuits.

A side of the robot body 100 is provided with a tracking transducer 700, and the tracking transducer 700 may be arranged at a side portion on the right front and/or the left front of the robot body 100. In an embodiment of the present application, that the side portion on the left front of the robot body 100 is provided with one tracking transducer 700 is taken as an example for illustration.

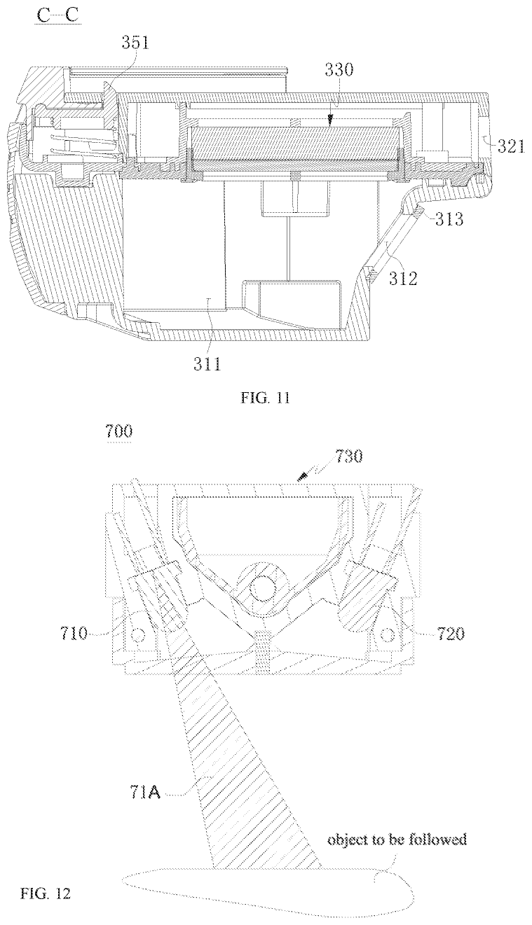

In an alternative embodiment, as shown in FIG. 12, the tracking transducer 700 includes an infrared emitter 710 and an infrared sensor 720, and the infrared emitter 710 and the infrared sensor 720 are arranged on a base 730. In a practical application, the light 71A emitted by the infrared emission tube 710 is received by the infrared sensor 720 after reflected by an object to be followed (such as a wall, a piece of furniture, an appliance etc.). The values output by the tracking transducer 700 involve in intensity information generated by the infrared sensor 720. The processor 410 may indirectly determine the distance between the cleaning robot 10 and the object to be followed based on the intensity information generated by the infrared sensor 720.

In an alternative embodiment, the tracking transducer 700 is a ranging sensor, such as an infrared ranging sensor that utilizes the TOF (Time of Flight) principle, such as an ultrasonic ranging sensor. The values output by the tracking transducer 700 involve in distance information generated by the ranging sensor, thereby directly determining the distance between the cleaning robot 10 and the object to be followed.

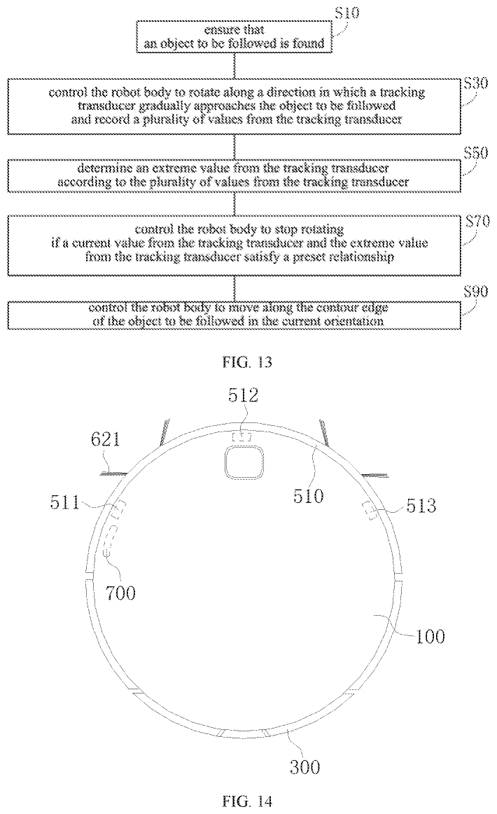

Referring to the flowchart in FIG. 13, in order to realize the function of cleaning along an edge, the processor 410 is configured to perform the following steps.

At S10, ensure that an object to be followed is found.

In the manner of finding an object to be followed, a combination including, but not limited to, one or more of the following three ways may be used to determine that the object to be followed is found.

The first way: after the collision component 510 contacts the object to be followed, a collision sensor corresponding to a collision area is triggered, so as to determine that the object to be followed is found. For example, the cleaning robot 10 with its structure simplified in FIG. 14 is taken as an example, three collision sensors, i.e. a left front collision sensor 511, a middle front collision sensor 512 and a right front collision sensor 513, are arranged at intervals between the collision component 510 and the robot body 100. Since the collision sensors are respectively provided in three different orientations, then when the left front area of the collision component 510 is subjected to a collision, the left front collision sensor 511 is triggered and it may be determined that the object to be followed is located at the left front of the cleaning robot 10; when the front area of the collision component 510 is subjected to a collision, the middle front collision sensor 512 is triggered and it may be determined that the object to be followed is located at the front of the cleaning robot 10; when the right front area of the collision component 510 is subjected to a collision, the right front collision sensor 513 is triggered and it may be determined that the object to be followed is located at the right front of the cleaning robot 10.

The second way: a side of the robot body 100 may be provided with an ultrasonic sensor, and the number of the ultrasonic sensor and the position for arranging the ultrasonic sensor may be adjusted according to the needs of a practical application, so as it can at least function as a tracking transducer.

The third way: the top of the robot body 100 may be provided with a lidar sensor, and the lidar sensor may measure the distance between the cleaning robot 10 and the object to be followed by using the principle of a triangulation method. In a practical application, in a case that the cleaning robot 10 is very close to the object to be followed, it is determined that the object to be followed is found.

At S30, control the robot body 100 to rotate along a direction in which a tracking transducer gradually approaches the object to be followed and record a plurality of values from the tracking transducer.

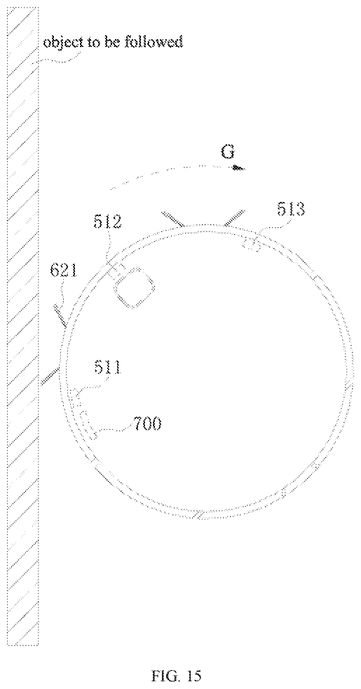

As shown in FIG. 15, the object to be followed is determined to be located at the left front of the cleaning robot 10 since the left front collision sensor 511 is triggered. Subsequently, the robot body 100 is controlled to rotate along the direction indicated by the arrow G through adjusting different speeds of the left wheel 110 and the right wheel, and the tracking transducer gradually approaches the object to be followed during the rotation of the robot body 100 along the direction indicated by the arrow G.

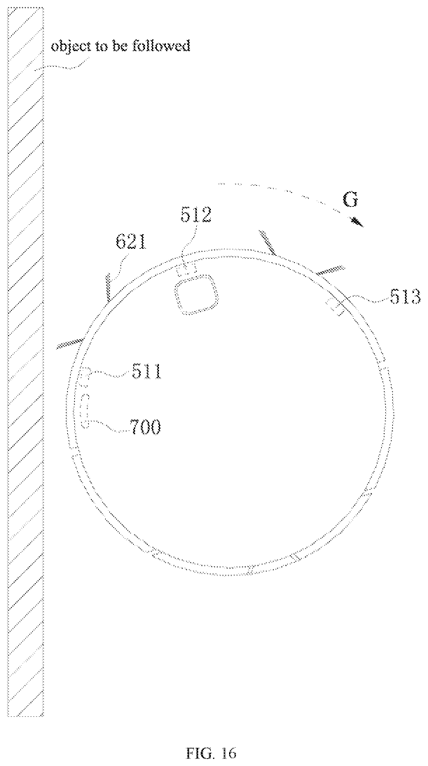

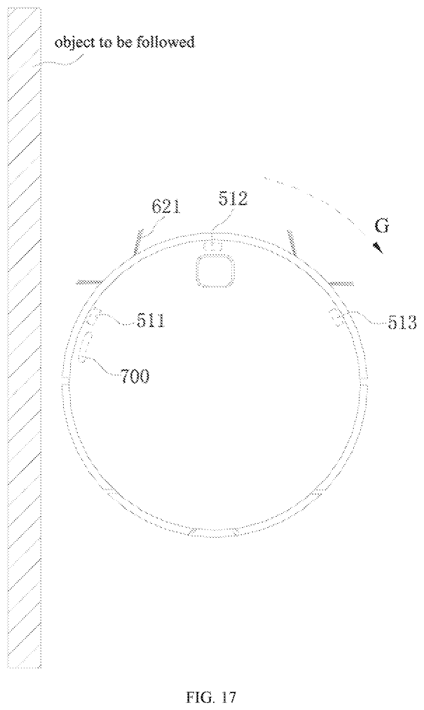

In this embodiment of the present application, the tracking transducer 700 disposed on the left front of the robot body 100 is taken as an example. During the robot body 100 rotates along the direction indicated by the arrow G, the tracking transducer 700 first approaches the object to be followed, and then the tracking transducer 700 gradually moves away from the object to be followed after the tracking transducer 700 is closest to the object to be followed. FIG. 16 shows the position state when the tracking transducer 700 is closest to the object to be followed. The process from FIG. 15 to FIG. 16 that the robot body 100 moves along the direction indicated by the arrow G is a process of the tracking transducer 700 from gradually approaching the object to be followed to most approaching the object to be followed, and the process from FIG. 16 to FIG. 17 that the robot body 100 moves along the direction indicated by the arrow G is a process of the tracking transducer 700 from most approaching the object to be followed to gradually moving away from the object to be followed.

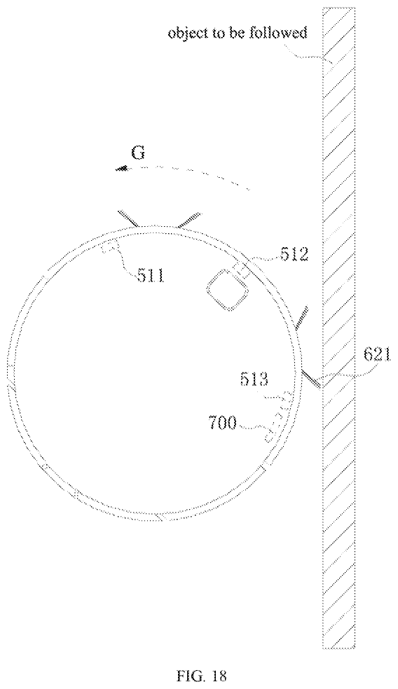

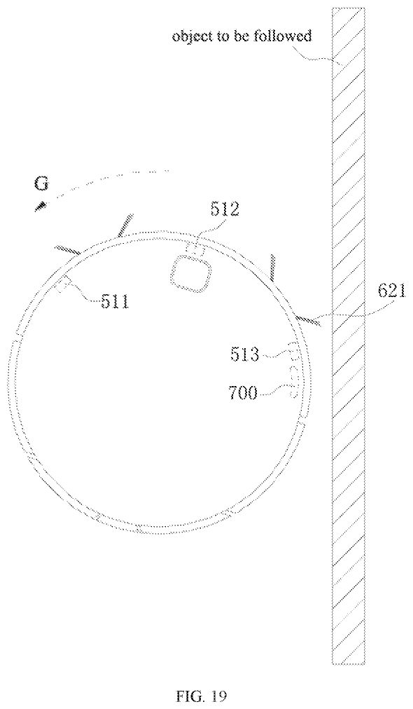

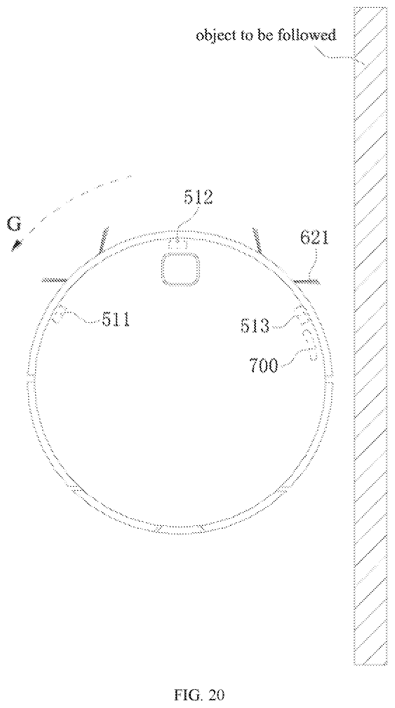

In other embodiments, as shown in FIG. 18 to FIG. 20, the tracking transducer 700 disposed on the right front of the robot body 100 is taken as an example. During the robot body 100 rotates along the direction indicated by the arrow G, the tracking transducer 700 first approaches the object to be followed, and then the tracking transducer 700 gradually moves away from the object to be followed after the tracking transducer 700 is closest to the object to be followed. FIG. 19 shows the position state when the tracking transducer 700 is closest to the object to be followed. The process from FIG. 18 to FIG. 19 that the robot body 100 moves along the direction indicated by the arrow G is a process of the tracking transducer 700 from gradually approaching the object to be followed to most approaching the object to be followed, and the process from FIG. 19 to FIG. 20 that the robot body 100 moves along the direction indicated by the arrow G is a process of the tracking transducer 700 from most approaching the object to be followed to gradually moving away from the object to be followed.

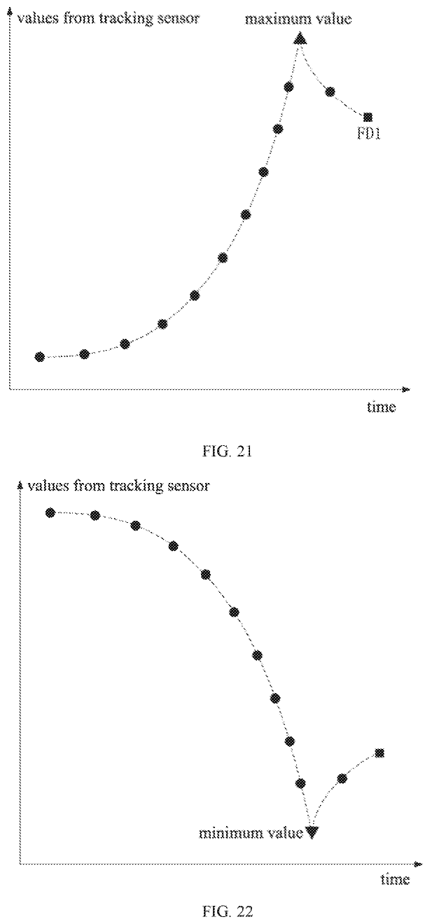

FIG. 21 is plotted based on that the values from the tracking transducer 700 involve in intensity information generated by the infrared sensor 720. During the rotation of the robot body 100 along the direction indicated by the arrow G, a plurality of values from the tracking transducer 700 are acquired and recorded at a certain sampling frequency. The black dots on the curve in FIG. 21 indicate the sampled values. According to the principle that the signal intensity received by the infrared sensor 720 is larger as the distance is closer, the curve in FIG. 21 shows an upward and then downward trend.

FIG. 22 is plotted based on that the values from the tracking transducer 700 involve in distance information generated by the ranging sensor. During the rotation of the robot body 100 along the direction indicated by the arrow G, a plurality of values from the tracking transducer 700 are acquired and recorded at a certain sampling frequency. The black dots on the curve in FIG. 22 indicate the sampled values. According to the principle that a value from the tracking transducer 700 is smaller as the distance is closer, the curve in FIG. 22 shows a downward and then upward trend.

At S50, determine an extreme value from the tracking transducer 700 according to the plurality of values from the tracking transducer 700.

The tracking transducer 700 including an infrared emitter 710 and an infrared sensor 720 is as an example, which corresponds to the curve in FIG. 21. Specifically, a maximum value from the tracking transducer 700 is determined according to the plurality of values from the tracking transducer 700, and an algorithm for solving a maximum value may be selected to determine the maximum value among the plurality of values from tracking transducer 700.

That the tracking transducer 700 is a ranging sensor is taken as example, which corresponds to the curve in FIG. 22. Specifically, a minimum value from the tracking transducer 700 is determined according to the values from the tracking transducer 700, and an algorithm for solving a minimum value may be selected to determine the minimum value among the plurality of values from tracking transducer 700

At S70, control the robot body 100 to stop rotating if a current value from the tracking transducer 700 and the extreme value from the tracking transducer 700 satisfy a preset relationship.

The tracking transducer 700 including the infrared emitter 710 and the infrared sensor 720 is taken as an example, which corresponds to the curve in FIG. 21. In order to ensure that the orientation of the cleaning robot 10 is substantially parallel to the contour edge of the object to be followed when the cleaning robot 10 stops rotating, it is considered as a determination condition that the current value from the tracking transducer 700 is less than or equal to a preset multiple K1 of the maximum value from the tracking transducer 700. When the determination condition is satisfied, the robot body 100 is controlled to stop rotating. The preset multiple K1≤1, which may be specifically adjusted according to the different position of the robot body 100 for mounting the tracking transducer 700. For convenience of reference in the following description, a current value from the tracking transducer 700 satisfied the determination condition is expressed as a tracking value FD1.

That the tracking transducer 700 is a ranging sensor is taken as an example, which corresponds to the curve in FIG. 22. In order to ensure that the orientation of the cleaning robot 10 is substantially parallel to the contour edge of the object to be followed when the cleaning robot 10 stops rotating, it is considered as a determination condition that the current value from the tracking transducer 700 is larger than or equal to a preset multiple K2 of the minimum value from the tracking transducer 700. When the determination condition is satisfied, the robot body 100 is controlled to stop rotating. The preset multiple K2≥1, which may be specifically adjusted according to the different position of the robot body 100 for mounting the tracking transducer 700. For convenience of reference in the following description, a current value from the tracking transducer 700 satisfied the determination condition is expressed as a tracking value FD2.

At S90, control the robot body 100 to move along the contour edge of the object to be followed in the current orientation.

The tracking transducer 700 including the infrared emitter 710 and the infrared sensor 720 is taken as an example. In a case when the robot body 100 is controlled to stop rotating and the tracking value FD1 is recorded, the robot body 100 is controlled to move along the contour edge of the object to be followed in the current orientation when the robot body 100 stops rotating. During the movement, the distance between the cleaning robot 10 and the contour edge of the object to be followed is adjusted in real time with reference to the tracking value FD1 to maintain a proper and stable distance.

That the tracking transducer 700 is a ranging sensor is taken as an example. In a case when the robot body 100 is controlled to stop rotating and the tracking value FD2 is recorded, the robot body 100 is controlled to move along the contour edge of the object to be followed in the current orientation when the robot body 100 stops rotating. During the movement, the distance between the cleaning robot 10 and the contour edge of the object to be followed is adjusted in real time with reference to the tracking value FD2 to maintain a proper and stable distance.

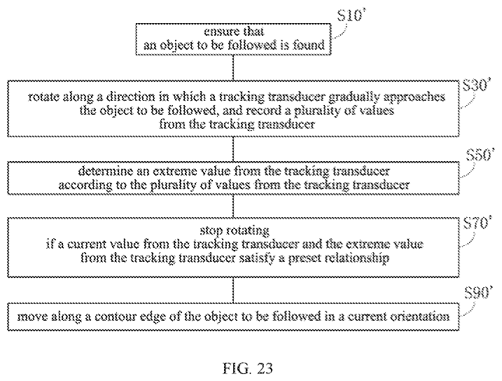

As shown in FIG. 23, an embodiment of the present application provides a method for cleaning along an edge, which is performed by a cleaning robot 10, and includes step S10′, step S30′, step S50′, step S70′, and step S90′.

The step S10′ includes ensuring that an object to be followed is found, the step S30′ includes rotating along a direction in which a tracking transducer gradually approaches the object to be followed and recording a plurality of values from the tracking transducer, the step S50′ includes determining an extreme value from the tracking transducer according to the plurality of values from the tracking transducer, the step S70′ includes stopping rotating if a current value from the tracking transducer and the extreme value from the tracking transducer satisfy a preset relationship, and the step S90′ includes moving along the contour edge of the object to be followed in the current orientation. In this embodiment of the present application, the explanations for the step S10′, step S30′, step S50′, step S70′, and step S90′ may refer to the above step S10, step S30, step S50, step S70, and step S90, which will not be repeated herein again.

The method for cleaning along an edge and the cleaning robot provided by the embodiments of the present application, ensure that an object to be followed is found, rotate along a direction in which a tracking transducer 700 gradually approaches the object to be followed and record a plurality of values from the tracking transducer 700, determine an extreme value from the tracking transducer 700 according to the plurality of values from the tracking transducer 700, stop rotating if a current value from the tracking transducer 700 and the extreme value from the tracking transducer 700 satisfy a preset relationship, and move along the contour edge of the object to be followed in the current orientation, which usually only needs rotating once to adjust the position and to be parallel to the contour edge of the object to be followed. The motion is smooth and unhindered, and the items will not be subjected to damage due to multiple adjustments and collisions, thereby the user experience is better.

In the description of the present specification, the description with reference to the terms “one embodiment”, “some embodiments”, “example”, “specific example” or “an alternative embodiment”, etc. is intended to indicate that a particular feature, structure, material or characteristic described in combination with said embodiment or example is included in at least one embodiment or example of the present application. In the present specification, the schematic representation of the above terms does not necessarily mean the same embodiment or example. Furthermore, the particular feature, structure, material, or characteristic described may be combined in a suitable manner in any one or more embodiments or examples.

The embodiments described above do not constitute a limitation on the protection scope of the technical solutions. Any modification, equivalent substitution and improvement made within the spirit and principles of the above-described implementations are intended to be included within the protection scope of the technical solutions.

What is claimed is:

1. A method for cleaning along an edge, performed by a cleaning robot, comprising:
ensuring that an object to be followed is found;
rotating along a direction in which a tracking transducer gradually approaches the object to be followed, and recording a plurality of values from the tracking transducer;
determining an extreme value from the tracking transducer according to the plurality of values from the tracking transducer;
stopping rotating if a current value from the tracking transducer and the extreme value from the tracking transducer satisfy a preset relationship;
moving along a contour edge of the object to be followed in a current orientation.

2. The method according to claim 1, wherein,
the step of determining an extreme value from the tracking transducer according to the plurality of values from the tracking transducer comprises: determining a maximum value from the tracking transducer according to the values from the tracking transducer;
the step of stopping rotating if a current value from the tracking transducer and the extreme value from the tracking transducer satisfy a preset relationship comprises: stopping rotating if the current value from the tracking transducer is less than or equal to a preset multiple of the maximum value from the tracking transducer.

3. The method according to claim 2, wherein the tracking transducer comprises an infrared emitter and an infrared sensor, and the values from the tracking transducer involve in intensity information generated by the infrared sensor.

4. The method according to claim 1, wherein,
the step of determining an extreme value from the tracking transducer according to the plurality of values from the tracking transducer comprises: determining a minimum value from the tracking transducer according to the values from the tracking transducer;
the step of stopping rotating if a current value from the tracking transducer and the extreme value from the tracking transducer satisfy a preset relationship comprises: stopping rotating if the current value from the tracking transducer is larger than or equal to a preset multiple of the minimum value from the tracking transducer.

5. The method according to claim 4, wherein the tracking transducer comprises a ranging sensor, and the values from the tracking transducer involve in distance information generated by the ranging sensor.

6. The method according to claim 1, wherein after moving along a contour edge of the object to be followed in a current orientation, the method further comprises: adjusting distance between the cleaning robot and the contour edge of the object to be followed during movement with reference to the current value from the tracking transducer.

7. A cleaning robot, comprising:
a robot body, a side portion of which is provided with a tracking transducer;
a mechanism for driving wheels, configured to drive the robot body to rotate and move;
a cleaning mechanism, configured to cleaning up garbage on the ground; and
a processor, configured to:
ensure that an object to be followed is found;
control the robot body to rotate along a direction in which a tracking transducer gradually approaches the object to be followed, and record a plurality of values from the tracking transducer;
determine an extreme value from the tracking transducer according to the plurality of values from the tracking transducer;
control the robot body to stop rotating if a current value from the tracking transducer and the extreme value from the tracking transducer satisfy a preset relationship;
control the robot body to move along a contour edge of the object to be followed in a current orientation.

8. The cleaning robot according to claim 7, wherein the processor is configured to:
determine a maximum value from the tracking transducer according to the values from the tracking transducer;
control the robot body to stop rotating if the current value from the tracking transducer is less than or equal to a preset multiple of the maximum value from the tracking transducer.

9. The cleaning robot according to claim 8, wherein the tracking transducer comprises an infrared emitter and an infrared sensor, and the values from the tracking transducer involve in intensity information generated by the infrared sensor.

10. The cleaning robot according to claim 7, wherein the processor is configured to:
determine a minimum value from the tracking transducer according to the values from the tracking transducer;
control the robot body to stop rotating if the current value from the tracking transducer is larger than or equal to a preset multiple of the minimum value from the tracking transducer.

11. The cleaning robot according to claim 10, wherein the tracking transducer comprises a ranging sensor, and the values from the tracking transducer involve in distance information generated by the ranging sensor.

12. The cleaning robot according to claim 7, wherein after moving along a contour edge of the object to be followed in a current orientation, the cleaning robot further comprises: adjusting distance between the cleaning robot and the contour edge of the object to be followed during movement with reference to the current value from the tracking transducer.

13. The method according to claim 2, wherein after moving along a contour edge of the object to be followed in a current orientation, the method further comprises: adjusting distance between the cleaning robot and the contour edge of the object to be followed during movement with reference to the current value from the tracking transducer.

14. The method according to claim 3, wherein after moving along a contour edge of the object to be followed in a current orientation, the method further comprises: adjusting distance between the cleaning robot and the contour edge of the object to be followed during movement with reference to the current value from the tracking transducer.

15. The method according to claim 4, wherein after moving along a contour edge of the object to be followed in a current orientation, the method further comprises: adjusting distance between the cleaning robot and the contour edge of the object to be followed during movement with reference to the current value from the tracking transducer.

16. The method according to claim 5, wherein after moving along a contour edge of the object to be followed in a current orientation, the method further comprises: adjusting distance between the cleaning robot and the contour edge of the object to be followed during movement with reference to the current value from the tracking transducer.

17. The cleaning robot according to claim 8, wherein after moving along a contour edge of the object to be followed in a current orientation, the cleaning robot further comprises: adjusting distance between the cleaning robot and the contour edge of the object to be followed during movement with reference to the current value from the tracking transducer.

18. The cleaning robot according to claim 9, wherein after moving along a contour edge of the object to be followed in a current orientation, the cleaning robot further comprises: adjusting distance between the cleaning robot and the contour edge of the object to be followed during movement with reference to the current value from the tracking transducer.

19. The cleaning robot according to claim 10, wherein after moving along a contour edge of the object to be followed in a current orientation, the cleaning robot further comprises: adjusting distance between the cleaning robot and the contour edge of the object to be followed during movement with reference to the current value from the tracking transducer.

20. The cleaning robot according to claim 11, wherein after moving along a contour edge of the object to be followed in a current orientation, the cleaning robot further comprises: adjusting distance between the cleaning robot and the contour edge of the object to be followed during movement with reference to the current value from the tracking transducer.
